(19) United States
(12) Patent Application Publication
(10) Pub. No.: US 2026/0289395 A1
(43) Pub. Date: Sep. 24, 2026

(54) SYSTEM AND METHOD FOR PROVIDING A QUANTITATIVE ANALYSIS AND EVALUATION OF AN ARTIFICIAL INTELLIGENCE MODEL

(71) Applicant: Panasonic Intellectual Property Management Co., Ltd., Osaka (JP)

(72) Inventors: MANISH GUPTA, Singapore (SG); CHANDRA SUWANDI WIJAYA, Singapore (SG); YUTA SHIMAZAKI, Osaka (JP); AKIRA MINEGISHI, Osaka (JP)

(21) Appl. No.: 19/087,633

(22) Filed: Mar. 24, 2025

(51) Int. Cl. G06N 20/00; G06F 40/226

(52) U.S. Cl. CPC G06N 20/00; G06F 40/226

(57) ABSTRACT

Disclosed herein is a method (800) for providing a quantitative analysis and evaluation of an artificial intelligence (AI) model (108). The method (800) includes receiving a textual dataset for a plurality of set of hyperparameters associated with the AI model (108) and forming a plurality of clusters associated with the plurality of training textual datasets in each of the plurality of set of hyperparameters. The method (800) includes computing a model score associated with each of the plurality of set of hyperparameters based on the plurality of testing textual datasets and the formed plurality of clusters and prioritizing at least one set of hyperparameters from each of the plurality of set of hyperparameters having a highest computed score model score. The method (800) includes providing the quantitative analysis and evaluation of the artificial intelligence (AI) model (108) by selecting the prioritized at least one set of hyperparameters.

### FIELD OF THE INVENTION

The present invention generally relates to the field of Artificial Intelligence, and more specifically relates to a system and method for providing a quantitative analysis and evaluation of an Artificial Intelligence (AI) Model.

### BACKGROUND

In recent years, Artificial intelligence (AI) has transformed industries and also assisted human beings in performing complex tasks with ease in different sectors, for example, industries, health, etc. AI refers to the development of computer systems or machines that can perform tasks that normally require human intelligence. These tasks include reasoning, problem-solving, learning, perception, and language understanding.

Natural Language Processing (NLP) is a subfield of AI that focuses on the interaction between computers and human language, enabling machines to understand, interpret, and generate human language in a valuable way. Within the realm of NLP, topic modelling techniques play a crucial role in uncovering hidden thematic structures in large collections of text data. Further, the topic modelling techniques include sub-techniques, such as Latent Dirichlet Allocation (LDA) and Non-negative Matrix Factorization (NMF). These sub-techniques perform to analyze the co-occurrence patterns of words to identify clusters that represent distinct topics.

However, there are certain challenges associated with each sub-technique, for example, evaluating the performance of each sub-technique. A key challenge in evaluating the performance of each sub-technique is the subjective nature of topic interpretation. Particularly, the sub-techniques form clusters based on the words, where the clusters represent distinct topics, however, the actual meaning and coherence of these topics can differ significantly based on the evaluator's perspective. Further, different human annotators can interpret the same topics in varying ways, leading to inconsistencies in evaluation metrics, such as coherence scores or human judgment assessments. Moreover, the absence of a standardized benchmark for comparison makes it difficult to evaluate or assess the performance of each sub-technique accurately, creating challenges in determining an efficient and accurate sub-technique, that provides the most meaningful and interpretable topics. Additionally, this challenge, as mentioned, mostly hinders the reproducibility of results by the topic modelling techniques and the development of reliable topic modelling techniques. Therefore, there is a need to develop a system to overcome the problem as discussed.

Many technological developments have been made to overcome the abovementioned problems. In this regard, in a known art, a method is disclosed for text classification by AI model. The method includes the steps of extracting a feature word set, inputting the feature word set into a text classification model, calculating the probability of each category of a preset categories to which a text belongs, and taking the category with the maximum probability value as the category to which the text belongs. Lastly, the method performs the text classification based on a comparison of predicted classification with a verification corpus using a pre-defined corpus. However, this method has certain limitations such as an absence of an optimal sub-technique for different scenarios, for example, different problems, impacting the reproducibility of results by the topic modelling techniques and the development of reliable topic modelling techniques.

In yet another known art, a system and method are disclosed for reducing cost and improving real-time performance for analyzing and representing customer care communication progression. The system analyzes and represents customer care communication based on tone assessments by monitoring communication between a plurality of customers and a plurality of representatives to form a plurality of interaction histories. The system and the method analyze a text form of the plurality of interaction histories according to a Tone Latent Dirichlet Allocation [T-LDA] model to determine a plurality of conversation tones. Thereafter, the system maps the plurality of conversation tones to a plurality of conversation phases and provides a representation of the conversation tones identifying a first customer tone at a first conversation phase and a second customer tone at a second conversation phase. However, the system and method have certain limitations such as an absence to provide an optimal sub-technique for different scenarios, for example, different problems, impacting the reproducibility of results by the topic modelling techniques and the development of reliable topic modelling techniques.

Therefore, there lies a need for an improved method and system capable of accurately evaluating the performance of the topic modelling techniques of the AI.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

In an embodiment, a method for providing a quantitative analysis and evaluation of an artificial intelligence (AI) model. The method includes receiving a textual dataset for a plurality of set of hyperparameters associated with the AI model. The textual dataset includes a plurality of training textual datasets and a plurality of testing textual datasets. The method includes forming a plurality of clusters associated with the plurality of training textual datasets in each of the plurality of set of hyperparameters based on the received textual dataset. The plurality of clusters includes similar training textual dataset from the plurality of training textual datasets. The method includes computing a model score associated with each of the plurality of set of hyperparameters based on the plurality of testing textual datasets and the formed plurality of clusters. The method includes prioritizing at least one set of hyperparameters from each of the plurality of set of hyperparameters having a highest computed score model score, based on the computed model score. The method includes providing the quantitative analysis and evaluation of the artificial intelligence (AI) model by selecting the prioritized at least one set of hyperparameters.

Also disclosed herein is a system for providing a quantitative analysis and evaluation of an artificial intelligence (AI) model. The system includes a memory and at least one processor in communication with the memory. The at least one processor is configured to receive a textual dataset for a plurality of set of hyperparameters associated with the AI model. The textual dataset includes a plurality of training textual datasets and a plurality of testing textual datasets. The at least one processor is configured to form a plurality of clusters associated with the plurality of training textual datasets in each of the plurality of set of hyperparameters based on the received textual dataset. The plurality of clusters includes similar training textual dataset from the plurality of training textual datasets. The at least one processor is configured to compute a model score associated with each of the plurality of set of hyperparameters based on the plurality of testing textual datasets and the formed plurality of clusters. The at least one processor includes prioritize at least one set of hyperparameters from each of the plurality of set of hyperparameters having a highest computed model score, based on the computed model score. The at least one processor is configured to provide the quantitative analysis and evaluation of the artificial intelligence (AI) model by selecting the prioritized at least one set of hyperparameters.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment for the implementation of a system for providing a quantitative analysis and evaluation of an artificial intelligence (AI) model, in accordance with an embodiment of the present disclosure;

FIG. 2 illustrates a block diagram of the system for providing the quantitative analysis and evaluation of the AI model, according to an embodiment of the present disclosure;

FIG. 3 illustrates a process-flow of an operation performed by the system, according to an embodiment of the present disclosure;

FIG. 4 illustrates a process-flow of an operation to compute a model score, according to an embodiment of the present disclosure;

FIGS. 5A-5B illustrate a graphical representation of a model score for BerTopic (Base Model-1), and BerTopic (Base Model-2) from the topic modelling techniques, according to an embodiment of the present disclosure;

FIG. 6 illustrates a graphical representation of a model score for Non-negative Matrix Factorization (NMF) from the topic modelling technique, according to an embodiment of the present disclosure;

FIG. 7 illustrates a sub-technique having an exemplary set of hyperparameters that are prioritized, to be notified to a user, according to another embodiment of the present disclosure; and

FIG. 8 illustrates a flow chart of a method for providing the quantitative analysis and evaluation of the AI model, according to an embodiment of the present disclosure.

Further, skilled artisans will appreciate that those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

Further, to address the challenges in evaluating topic modelling algorithms, a system, and method are developed where the system and method use a hybrid framework that combines traditional methods, such as coherence scores, with an accuracy metric derived from a small subset of the available training dataset. This innovative approach allows for a more nuanced assessment of topic quality by not only measuring the coherence of the generated topics but also evaluating the accuracy of the clusters formed by the system. The accuracy score may be computed by leveraging clustering techniques. Further, by integrating coherence scores with accuracy metrics, this framework enables fine-tuning the hyperparameters of various topic modelling techniques. This iterative process leads to improved model performance, as it provides a dual option through which to assess and optimize the generated topics, ultimately resulting in more meaningful and interpretable outcomes in natural language processing tasks.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Embodiments will be described below in detail with reference to the accompanying drawings.

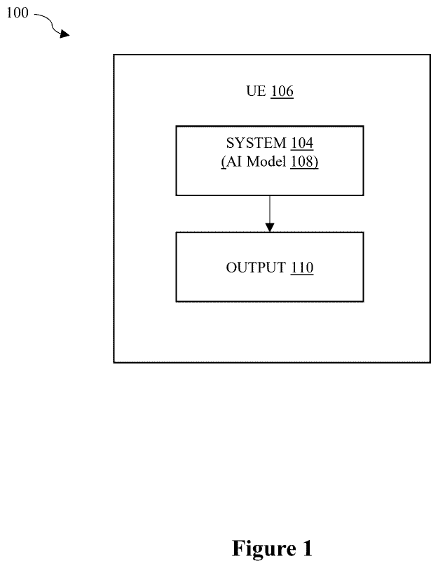

FIG. 1 illustrates a schematic block diagram depicting an environment 100 for the implementation of a system 104 for providing a quantitative analysis and evaluation of an Artificial Intelligence Model 108, according to an embodiment of the present disclosure. In an embodiment, the system 104 may be deployed in a user equipment 106. In another embodiment, the system 104 may be communicably coupled with the user equipment 106. In yet another embodiment, the system 104 may reside in a cloud server, without departing from the scope of the present disclosure. In an embodiment, the system 104 may be compatible with the AI model 108, without departing from the scope of the present disclosure. In an embodiment, the user equipment (UE) 106 may be a laptop, a computer, or any other electronic device, without departing from the scope of the present disclosure.

In some example scenarios, in an industry, there is a possibility that the user may face constraints while providing solutions corresponding to diagnosed faults in various components. So, in that case, the AI model 108 assists the user in providing the solution via the UE 106. However, there is a possibility that the solution provided by the AI model 108 may not be accurate or as per the user's interpretation.

Particularly, the AI model 108 provides the solution by performing a topic modelling technique. The topic modelling technique may be used to discover abstract topics within a collection of text. Particularly, the topic modelling technique may include a plurality of sub-techniques (referred to herein as sub-techniques), where any of the plurality of sub-techniques operates to provide the required solutions to the user. The sub-techniques may include, but is not limited to, Latent Dirichlet Allocation (LDA), Non-negative Matrix Factorization (NMF), BerTopic, etc. However, there is a possibility that the solution provided by any of the sub-techniques as mentioned may not be accurate or as per the user's interpretation.

Thus, to evaluate the performance or operations of each of the sub-technique to provide the accurate solution to the user, the system 104 is disclosed. The system 104 receives a plurality of textual data as an input and based on the input, provides an output 110. The output 110 indicates the quantitative analysis and evaluation of the AI model 108. Particularly, the system 104 provides the quantitative analysis and evaluation of the sub-techniques of the topic modelling technique in the AI model 108. This process assists the AI model 108 in generating the accurate and most prioritized solution for the user as required. In an embodiment, the AI model 108 may be a Natural Language Processing (NLP) based AI model 108 configured to perform the topic modelling technique, without departing from the scope of the present disclosure.

In an embodiment, the operation of the system 104 is discussed, in the subsequent paragraphs, with reference to the at least one of the plurality of sub-techniques, for example, LDA, for the sake of brevity. However, it may be noted by a person skilled in the art that the operation as discussed in the subsequent paragraphs is also applicable for the remaining sub-techniques, without departing from the scope of the present disclosure.

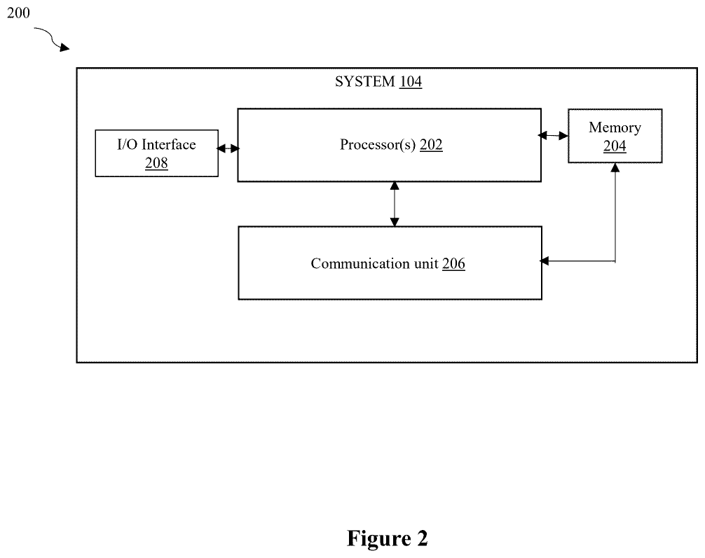

FIG. 2 illustrates a block diagram 200 of the system 104 for providing the quantitative analysis and evaluation of the AI model 108, according to an embodiment of the present disclosure.

The system 104 includes at least one processor (referred to herein as a processor) 202, a memory 204, a communication unit 206, and an input/output (I/O) interface 208. The system 104 may correspond to one of a server at a user location, a remote server, a user device, or any other electronic device. In one or more embodiments, the system 104 may include a combination of an electronic device and a server.

The processor(s) 202 can be a single processing unit or several units, all of which could include multiple computing units. The processor 202 may be in communication with the memory 204. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 includes one or more computer-readable storage media. The memory 204 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 204 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The communication unit 206 is configured to communicate data or any other signal over a communication network. Further, the communication unit 206 may include a communication port, a communication interface, or a transceiver for sending and receiving signals from the system 104 via the communication network. The communication port or the communication interface may be a part of a processing unit or may be a separate component. The communication port may be created in software or may be a physical connection in hardware. The communication port may be configured to connect with the communication network, external media, the display, or any other components in the system 104, or combinations thereof. The connection with the communication network may be a physical connection, such as a wired Ethernet connection, or may be established wirelessly as discussed above. Likewise, the additional connections with other components of the system 104 may be physical or may be established wirelessly.

The I/O interface 208 refers to hardware or software components that enable communication between the system 104 and any other electronic device. The I/O interface 107 serves as a communication medium for exchanging information, commands, signals, or query responses with other devices or systems. The I/O interface 208 may be a part of the processor 202 or may be a separate component. The I/O interface 208 may be created in software or may be a physical connection in hardware. The I/O interface 208 may be configured to connect with an external network, external media, the display, or any other components, or combinations thereof. The external network may be a physical connection, such as a wired Ethernet connection, or may be established wirelessly.

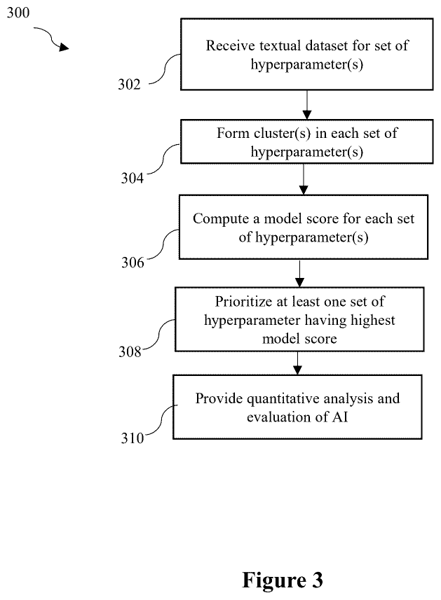

In one or more embodiments, one or more functions associated with the system 104 may be performed through the non-volatile memory, the volatile memory, and the processor 202 as explained in FIGS. 3 to 7 in conjunction with FIG. 2.

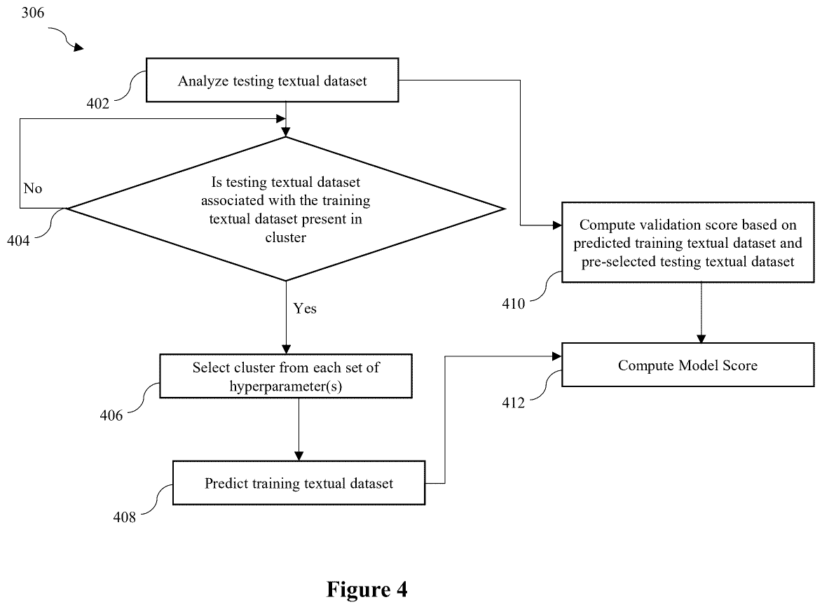

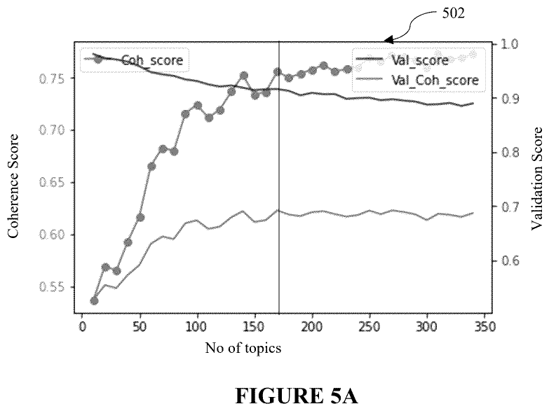

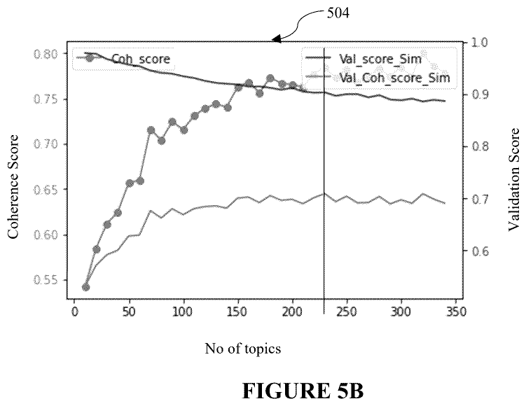

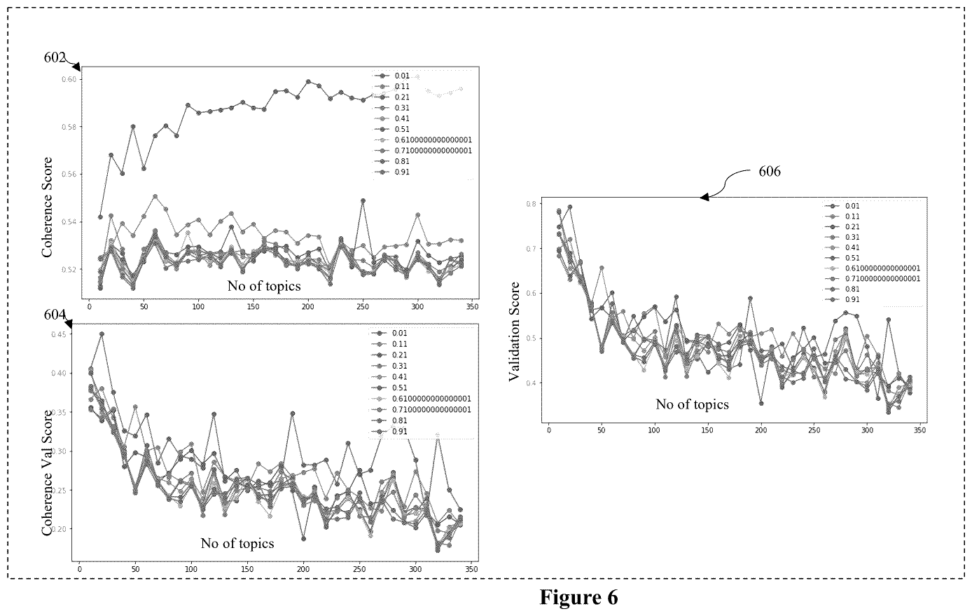

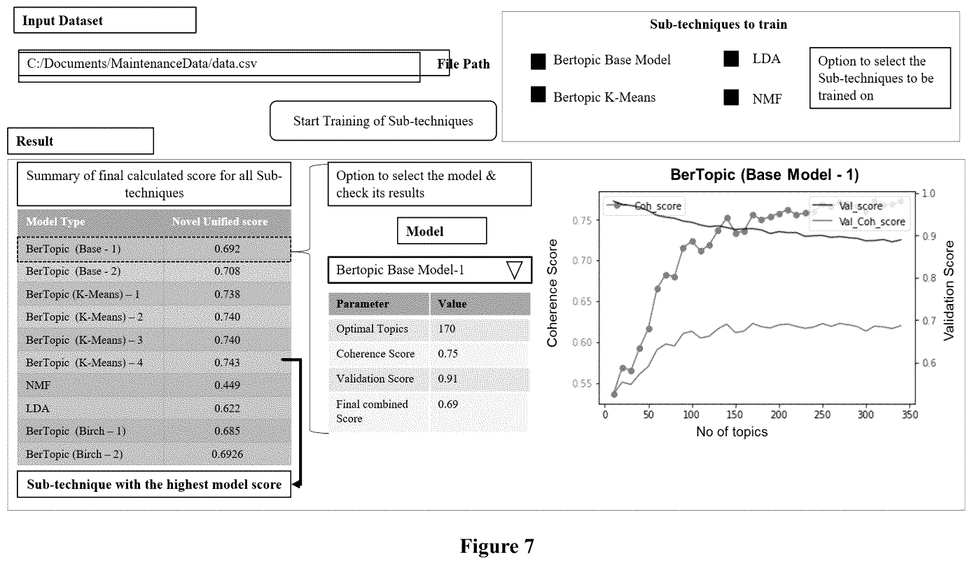

FIG. 3 illustrates a process-flow of an operation 300 performed by the system 104, according to an embodiment of the present disclosure. FIG. 4 illustrates a process-flow of an operation to compute a model score, according to an embodiment of the present disclosure. FIGS. 5A-5B illustrate a graphical representation of a model score for BerTopic (Base Model-1), and BerTopic (Base Model-2) from the topic modelling techniques, according to an embodiment of the present disclosure. FIG. 6 illustrates a graphical representation of a model score for Non-negative Matrix Factorization (NMF) from the topic modelling technique, according to an embodiment of the present disclosure. FIG. 7 illustrates a sub-technique having an exemplary set of hyperparameters that are prioritized, to be notified to a user, according to another embodiment of the present disclosure.

In an embodiment, FIGS. 3 to 7 may be explained in conjunction for the sake of brevity.

In an embodiment, at block 302, the processor 202 may be configured to receive a textual dataset for a plurality of set of hyperparameters associated with the AI model 108. The processor 202 may be configured to receive the textual dataset from the I/O interface 208, without departing from the scope of the present disclosure. The textual dataset may be provided by the user via the I/O interface 208, without departing from the scope of the present disclosure. The textual dataset may include a plurality of training textual datasets and a plurality of testing textual datasets (referred to herein as the testing textual dataset). The textual dataset is a collection of data having primary content in the form of text. In an example, the textual dataset may include text related to problems and corresponding solutions, questions and related answers, cause and effect, etc. Herein the textual dataset includes problems, and corresponding solutions related a motor, a gear, and a winding in a plurality of components in the industry as shown in Table 1 provided below:

TABLE 1

| Problem | Solution |
|---|---|
| Motor-related Problem 1 | Motor-related Solution 1 |
| Motor-related Problem 2 | Motor-related Solution 2 |
| Motor-related Problem 3 | Motor-related Solution 3 |
| Winding-related Problem 1 | Motor-related Solution 1 |
| Winding-related Problem 2 | Motor-related Solution 2 |
| Winding-related Problem 3 | Motor-related Solution 3 |
| Gear-related Problem 1 | Gear-related Solution 1 |

Further, the AI model 108 may be pre-trained with the plurality of set of hyperparameters. The hyperparameter may be defined as a parameter that is set in the AI model 108 before the training. In an example, the plurality of set of hyperparameters may be a first set of hyperparameters including α₁, β₁, γ₁, a second set of hyperparameters including α₂, β₂, γ₂, . . . , a Nth set of hyperparameter including αₙ, βₙ, γₙ.

In an embodiment, further, the processor 202 may be configured to train the AI model 108 based on the plurality of training textual datasets. In such an embodiment, the plurality of training textual datasets may be a problem dataset from the textual dataset as shown in Table 2.

TABLE 2
Problem Dataset

Motor-related Problem 1
Motor-related Problem 2
Motor-related Problem 3
Winding-related Problem 1
Winding-related Problem 2
Winding-related Problem 3
Gear-related Problem 1

In an embodiment, at block 304, the processor 202 may be configured to form a plurality of clusters associated with the plurality of training textual datasets in each of the plurality of set of hyperparameters. The cluster may be defined as a group of similar things or elements that are close together or share common characteristics. The processor 202 may be configured to form the plurality of clusters based on the received textual dataset. The plurality of clusters may include similar training textual dataset from the plurality of training textual datasets. In an example, the plurality of clusters as formed in the first set of hyperparameters may be shown in Table 3, as provided below:

TABLE 3

| Problem Dataset | Solution Dataset | Formed Cluster |
|---|---|---|
| Motor-related Problem 1 | Motor-related Solution 1 | 1 |
| Motor-related Problem 2 | Motor-related Solution 2 | 1 |
| Motor-related Problem 3 | Motor-related Solution 3 | 1 |
| Winding-related Problem 1 | Motor-related Solution 1 | 2 |
| Winding-related Problem 2 | Motor-related Solution 2 | 2 |
| Winding-related Problem 3 | Motor-related Solution 3 | 2 |
| Gear-related Problem 1 | Gear-related Solution 1 | 3 |

Similarly, the plurality of clusters may be formed in the second set of hyperparameters, . . . , and the Nth set of hyperparameters.

In an embodiment, at block 306, the processor 202 may be configured to compute the model score associated with each of the plurality of set of hyperparameters. The model score is defined as a numerical evaluation that reflects the performance or quality of the AI model 108. The processor 202 may be configured to compute the model score based on the plurality of testing textual datasets and the formed plurality of clusters. Further, the operations performed by the processor 202 to compute the model score are explained in subsequent paragraphs with respect to FIG. 4.

In such an embodiment, referring to FIG. 4, at block 402, the processor 202 may be configured to analyze the testing textual dataset. The testing textual dataset may form part of the textual dataset and is provided by the user. In an example, the testing textual dataset includes a motor-related problem 4, a motor-related problem 5, and corresponding solutions, i.e., actual solution dataset, as shown in the Table 4 provided below. Further, the problem dataset and the corresponding solution dataset as shown in the Table 4 may be derived by the user:

TABLE 4

| Problem Dataset | Solution Dataset (Actual Solution Dataset) |
|---|---|
| Motor-related Problem 4 | Motor-related Solution 4 |
| Motor-related Problem 5 | Motor-related Solution 5 |

Thereafter, at block 404, the processor 202 may be configured to correlate each of the plurality of testing textual datasets with the formed plurality of clusters in each of the plurality of set of hyperparameters. The processor 202 may be configured to correlate if each of the plurality of testing textual datasets is associated with the plurality of training textual datasets present in at least one cluster.

Further, the at step 406, the processor 202 may be configured to select the at least one cluster from the plurality of clusters corresponding to each of the plurality of set of hyperparameters. Furthermore, the processor 202 may be configured to select the at least one cluster, when or upon determination that each of the plurality of testing textual datasets is associated with the plurality of training textual datasets present in the at least one cluster. Further, based on the correlation, when the processor 202 may determine that each of the plurality of testing textual datasets may not be associated with the plurality of training textual datasets present in the at least one cluster, consequently, the operation returns to step 402.

In an example, the plurality of testing textual datasets is related to the motor-related problem 4, motor-related problem 5, and corresponding solutions. Thereafter, the processor 202 correlates each of the motor-related problem 4, motor-related problem 5, and corresponding solutions with the formed clusters as shown in the Table 3. The processor 202 correlates if each of the motor-related problem 4, motor-related problem 5, and corresponding solutions are associated with the plurality of training textual datasets, i.e., related to the motor, present in at least one cluster, i.e., cluster 1, from the plurality of clusters. Thereafter, the processor 202 may be configured to select the at least one cluster, i.e., cluster 1 from the plurality of clusters in the first set of hyperparameters as shown in Table 5 below:

TABLE 5

| Problem | Actual Solution Dataset | Selected Cluster |
|---|---|---|
| Motor-related Problem 4 | Motor-related Solution 4 | 1 |
| Motor-related Problem 5 | Motor-related Solution 5 | 1 |

Similarly, the processor 202 may be configured to select the at least one cluster, i.e., a cluster 2 from the plurality of clusters in the second set of hyperparameters, . . . , a cluster 3 from the plurality of clusters in the nth set of hyperparameters.

At step 408, the processor 202 may be configured to predict at least one training textual dataset from the selected at least one cluster. In an example, the at least one training textual dataset may indicate corresponding solutions with respect to the problem, from the cluster 1, which is shown in Table 6 below:

TABLE 6

| | Actual Solution | Selected | Predicted |
|---|---|---|---|
| Problem | Dataset | Cluster | Solution |
| Motor-related Problem 4 | Motor-related | 1 | Motor-related |
| | Solution 4 | | solution 1, 2, 3 |
| Motor-related Problem 5 | Motor-related | 1 | Motor-related |
| | Solution 5 | | solution 1, 2, 3 |

Similarly, the processor 202 may be configured to predict the training textual dataset from the cluster 2 in the second set of hyperparameters, predict the training textual dataset from the cluster 3 in the nth set of hyperparameters.

At step 410, the processor 202 may be configured to compute a validation score associated with each of the plurality of set of hyperparameters. The processor 202 may be configured to compute the validation score based on a comparison of the predicted at least one training textual dataset and a pre-selected testing textual dataset from the plurality of testing textual datasets using a predefined technique. In an embodiment, the pre-selected testing textual dataset may indicate the actual solution dataset, without departing from the scope of the present disclosure. In an embodiment, the predefined technique may be a Jaccard similarity technique. The validation score may be defined as a performance metric of the AI model 108, when evaluated on a data that is not used during the training of the AI model 108.

In an example, the pre-selected or actual testing textual dataset is the motor-related solution 4 and motor-related solution 5. Further, the predicted at least one training textual dataset is motor-related solution 1, 2, 3 in the first set of hyperparameters. Thereafter, based on the Jaccard similarity technique, the validation score is computed by the processor 202 for the first set of hyperparameters. Similarly, the validation score is computed for the second set of hyperparameters, . . . for the nth set of hyperparameters.

At step 412, the processor 202 may be configured to compute the model score associated with each of the plurality of set of hyperparameters. The processor 202 may be configured to compute the model score, based on the computed validation score and a coherence score associated with each of the plurality of testing textual datasets. In an embodiment, the coherence score associated with the plurality of testing textual datasets may be stored in the processor 202. The coherence score may be defined as a score which indicates how well the words within each topic are connected with each other together.

In an embodiment, again referring to FIG. 3, at block 308, the processor 202 may be configured to prioritize at least one set of hyperparameters from each of the plurality of set of hyperparameters having a highest computed model score. The processor 202 may be configured to prioritize the at least one set of hyperparameters based on the computed model score. In an example, the first set of hyperparameters may have the highest model score as compared to the second set of hyperparameters, . . . , the nth set of hyperparameters. So, the first set of hyperparameters may be prioritized.

In one embodiment, at block 310, the processor 202 may be configured to provide the quantitative analysis and evaluation of the AI model 108 by selecting the prioritized at least one set of hyperparameters. The quantitative analysis and the evaluation as provided ensure the optimum operation of the sub-technique of the topic modelling technique, thus generating αₙ accurate solution to the user as per his/her requirement unlike existing art.

In an example, the processor 202 may be configured to provide the quantitative analysis and evaluation of the AI model 108 by selecting the first set of hyperparameters. The first set of hyperparameters provides the accurate and prioritized solution as the motor solution 1, 2, and 3, stored in the processor 202, for the motor-related problems 4 and 5. Thus, the quantitative analysis and evaluation of the AI model 108 indicates the prioritized solution as the motor solutions 1, 2, and 3 for the motor-related problems 4 and 5 to the user. This ensures ease of providing the prioritized and accurate solutions to the user.

In another embodiment, after selecting the first set of hyperparameters, the processor 202, simultaneously, may be configured to perform operations as mentioned above for each of the sub-techniques. Based on the operations, the processor 202 may be configured to generate the model score as shown in FIGS. 5A-5B and 6 depicted by 502, 504, 602, 604, and 606, for each of the plurality of set of hyperparameters for each of the sub-techniques. Thereafter, based on the model score, the processor 202 may be configured to prioritize at least one set of hyperparameters from each of the plurality of set of hyperparameters having the highest computed model score among each of the sub-technique as shown in Table 7:

TABLE 7

| | Validation using 20% textual dataset | | | |
|---|---|---|---|---|
| | Optimal No | Coherence | Validation | Total score |
| Sub-techniques | of Topics | Score | Score | (Coh*Val) |
| BerTopic (Base - 1) | 170 | 0.755 | 0.916 | 0.692 |
| BerTopic (Base - 2) | 230 | 0.784 | 0.902 | 0.708 |
| BerTopic | 60 | 0.790 | 0.934 | 0.738 |
| (K-Means) - 1 | | | | |
| BerTopic | 60 | 0.790 | 0.936 | 0.740 |
| (K-Means) - 2 | | | | |
| BerTopic | 60 | 0.785 | 0.942 | 0.740 |
| (K-Means) - 3 | | | | |
| BerTopic | 60 | 0.791 | 0.938 | 0.743 |
| (K-Means) - 4 | | | | |
| NMF | 20 | 0.568 | 0.791 | 0.449 |
| LDA | 200 | 0.630 | 0.987 | 0.622 |
| BerTopic (Birch - 1) | 100 | 0.739 | 0.926 | 0.685 |
| BerTopic (Birch - 2) | 100 | 0.744 | 0.930 | 0.6926 |

In another embodiment, the processor 202 may be configured to provide the quantitative analysis and evaluation of the AI model 108 by selecting the prioritized at least one set of hyperparameters. In an example, the processor 202 may provide the quantitative analysis and evaluation of the AI model 108 based on the at least one set of hyperparameters of the BerTopic (K-Means)-4 sub-technique as the at least one set of hyperparameters of the BerTopic (K-Means)-4 sub-technique have the highest model score as shown in Table 8A and 8B for clarity.

TABLE 8A

| Sub-technique | Model Score |
|---|---|
| BerTopic (Base-1) | 0.692 |
| BerTopic (Base-2) | 0.708 |
| BerTopic (K-Means)-1 | 0.738 |
| BerTopic (K-Means)-2 | 0.740 |
| BerTopic (K-Means)-3 | 0.740 |
| BerTopic (K-Means)-4 | 0.743 |
| NMF | 0.449 |
| LDA | 0.622 |
| BerTopic (Birch-1) | 0.685 |
| BerTopic (Birch-2) | 0.6926 |

TABLE 8B

| Sub-technique | Model Score |
|---|---|
| Optimal Topics | 60 |
| Coherence Score | 0.791 |
| Validation Score | 0.938 |
| Model Score/Final Combined Score | 0.743 |

Thus, herein the at least one set of hyperparameters having the highest model score may be prioritized from the BerTopic (K-Means)-4 sub-technique and accordingly, may be notified to the user via the UE 106 as shown in FIG. 7.

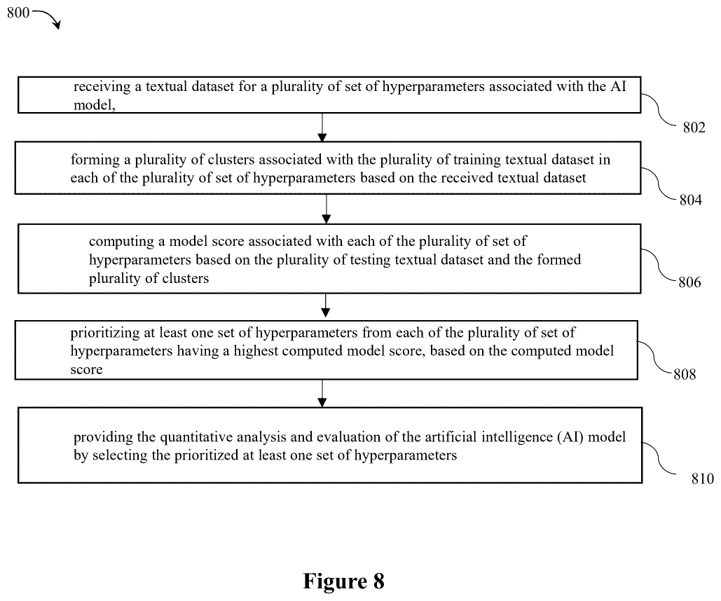

FIG. 8 illustrates a flow chart of a method 800 for providing the quantitative analysis and evaluation of the AI model 108, according to an embodiment of the present disclosure. The method 800 includes a series of steps 802 through 810 performed by the processor 202.

At step 802, the method 800 includes receiving the textual dataset for the plurality of set of hyperparameters associated with the AI model 108. The textual dataset may include the plurality of training textual datasets, and the plurality of testing textual datasets.

The method 800 includes training the AI model 108 based on the plurality of training textual datasets.

At step 804, the method 800 includes forming the plurality of clusters associated with the plurality of training textual datasets in each of the plurality of set of hyperparameters based on the received textual dataset. The plurality of clusters may include similar training textual dataset from the plurality of training textual datasets.

At step 806, the method 800 includes computing the model score associated with each of the plurality of set of hyperparameters based on the plurality of testing textual datasets and the formed plurality of clusters.

The method 800 includes correlating each of the plurality of testing textual datasets with the formed plurality of clusters in each of the plurality of set of hyperparameters. The method 800 includes selecting the at least one cluster from the plurality of clusters in each of the plurality of set of hyperparameters, when each of the plurality of testing textual datasets is associated with the plurality of training textual datasets present in the at least one cluster. The method 800 includes predicting the at least one training textual dataset from the selected at least one cluster. The method 800 includes computing the validation score associated with each of the plurality of set of hyperparameters based on the comparison of the predicted at least one training textual dataset and the pre-selected testing textual dataset from the plurality of testing textual datasets using the predefined technique. The predefined technique may be the Jaccard similarity technique. The method 800 includes computing the model score associated with each of the plurality of set of hyperparameters based on the computed validation score and the coherence score associated with each of the plurality of testing textual datasets.

At step 808, the method 800 includes prioritizing the at least one set of hyperparameters from each of the plurality of set of hyperparameters having the highest computed model score, based on the computed model score.

At step 810, the method 800 includes providing the quantitative analysis and evaluation of the artificial intelligence (AI) model by selecting the prioritized at least one set of hyperparameters.

While the above discussed steps in FIG. 8 are shown and described in a particular sequence, the steps may occur in variations to the sequence in accordance with various embodiments. Further, a detailed description related to the various steps of FIG. 8 is already covered in the description related to FIGS. 2 to 7 and is omitted herein for the sake of brevity.

The system 104 and the method 800 as disclosed provide an efficient and accurate quantitative analysis and the evaluation of each sub-technique of the topic modelling technique of the AI model 108. The system 104 and the method 800 select the at least one set of hyperparameters based on the computed model score, where the model score is computed based on the validation score and the coherence score. This configuration enhances the robustness of the operation to provide the evaluation of the AI model 108 and also facilitates a more iterative and data-driven optimization of hyperparameters. By leveraging both the coherence score and the validation score, the system 104 addresses the subjective nature of topic interpretation and provides a systematic way to refine topic modelling algorithms, thus ultimately improving the interpretability and relevance of topics generated, making it a significant advancement in the field of natural language processing. Further, the system 104 and the method 800 as disclosed provide an optimal sub-technique for different scenarios, for example different problems, thereby improving the reproducibility of results by the topic modelling techniques and the development of reliable topic modelling techniques.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method for providing a quantitative analysis and evaluation of an artificial intelligence (AI) model, the method comprising:
receiving a textual dataset for a plurality of set of hyperparameters associated with the AI model, wherein the textual dataset comprises a plurality of training textual datasets, and a plurality of testing textual datasets;
forming a plurality of clusters associated with the plurality of training textual datasets in each of the plurality of set of hyperparameters based on the received textual dataset, wherein the plurality of clusters includes similar training textual dataset from the plurality of training textual datasets;
computing a model score associated with each of the plurality of set of hyperparameters based on the plurality of testing textual datasets and the formed plurality of clusters;
prioritizing at least one set of hyperparameters from each of the plurality of set of hyperparameters having a highest computed model score, based on the computed model score; and
providing the quantitative analysis and evaluation of the artificial intelligence (AI) model by selecting the prioritized at least one set of hyperparameters.

2. The method as claimed in claim 1, wherein prior to forming the plurality of clusters, the method comprises:
training the AI model based on the plurality of training textual datasets.

3. The method as claimed in claim 1, wherein computing the model score comprises:
correlating each of the plurality of testing textual datasets with the formed plurality of clusters in each of the plurality of set of hyperparameters;
selecting at least one cluster from the plurality of clusters corresponding to each of the plurality of set of hyperparameters, when each of the plurality of testing textual datasets is associated with the plurality of training textual datasets present in the at least one cluster;
predicting at least one training textual dataset from the selected at least one cluster;
computing a validation score associated with each of the plurality of set of hyperparameters based on a comparison of the predicted at least one training textual dataset and a pre-selected testing textual dataset from the plurality of testing textual datasets using a predefined technique; and
computing the model score associated with each of the plurality of set of hyperparameters based on the computed validation score and a coherence score associated with each of the plurality of testing textual datasets.

4. The method as claimed in claim 3, wherein the predefined technique is a Jaccard similarity technique.

5. A system for providing a quantitative analysis and evaluation of an artificial intelligence (AI) model, the system comprising:
a memory;
at least one processor in communication with the memory, the at least one processor is configured to:
receive a textual dataset for a plurality of set of hyperparameters associated with the AI model, wherein the textual dataset comprises a plurality of training textual datasets, and a plurality of testing textual datasets;
form a plurality of clusters associated with the plurality of training textual datasets in each of the plurality of set of hyperparameters based on the received textual dataset, wherein the plurality of clusters includes similar training textual dataset from the plurality of training textual datasets;
compute a model score associated with each of the plurality of set of hyperparameters based on the plurality of testing textual datasets and the formed plurality of clusters;
prioritize at least one set of hyperparameters from each of the plurality of set of hyperparameters having a highest computed model score, based on the computed model score; and
provide the quantitative analysis and evaluation of the artificial intelligence (AI) model by selecting the prioritized at least one set of hyperparameters.

6. The system as claimed in claim 5, wherein prior to forming the plurality of clusters, the at least one processor is configured to:
train the AI model based on the plurality of training textual datasets.

7. The system as claimed in claim 5, wherein to compute the model score, the at least one processor is configured to:
correlate each of the plurality of testing textual datasets with the formed plurality of clusters in each of the plurality of set of hyperparameters;
select at least one cluster from the plurality of clusters corresponding to each of the plurality of set of hyperparameters, when each of the plurality of testing textual datasets is associated with the plurality of training textual datasets present in the at least one cluster;
predict at least one training textual dataset from the selected at least one cluster;
compute a validation score associated with each of the plurality of set of hyperparameters based on a comparison of the predicted at least one training textual dataset and a pre-selected testing textual dataset from the plurality of testing textual datasets using a predefined technique; and
compute the model score associated with each of the plurality of set of hyperparameters based on the computed validation score and a coherence score associated with each of the plurality of testing textual datasets.

8. The system as claimed in claim 7, wherein the predefined technique is a Jaccard similarity technique.
